(19) United States
(12) Patent Application Publication
(10) Pub. No.: US 2008/0232145 A1
(43) Pub. Date: Sep. 25, 2008

(54) Inverter Circuit with Distributed Energy Stores

(75) Inventors: Marc Hiller, Nurnberg (DE); Rainer Sommer, Heroldsbach (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/064,897

(22) PCT Filed: Jul. 31, 2006
(86) PCT No.: PCT/EP2006/064828

§ 371 Date: Feb. 26, 2008

(30) Foreign Application Priority Data
Aug. 26, 2005 (DE) 10 2005 040 543.6

(51) Int. Cl. H02H 7/122

(52) U.S. Cl. 363/56.01

(57) ABSTRACT

The invention relates to a rectifier circuit comprising a phase module (110) with at least one upper and one lower rectifier valve (T1, . . . , T6), said phase module (100) being electrically connected on the DC side to a positive and a negative DC busbar (P0, N0), each rectifier valve (T1, . . . , T6) having at least two bipolar subsystems (10) electrically connected in series. According to the invention, a protection component (12) is connected in parallel to the connector contacts (X1, X2) of each subsystem (10). A rectifier circuit is thus obtained with distributed energy stores which can be operated redundantly in case of fault.

The invention relates to an inverter circuit according to the preamble of claim 1.

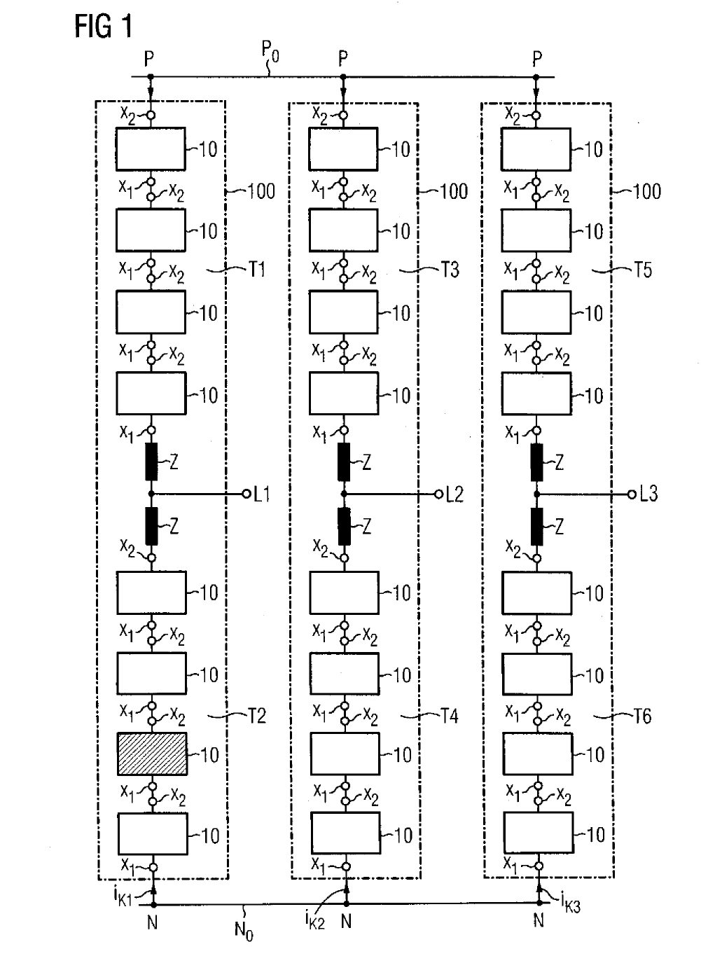

An inverter circuit of this generic type is disclosed in DE 101 03 031 A1, and an equivalent circuit of such an inverter circuit is shown in greater detail in FIG. 1. As shown in this equivalent circuit, this known inverter circuit has three phase modules, each denoted by 100. These phase modules 100 are each electrically connected on the DC side to a positive and a negative DC busbar P₀ and N₀. A DC voltage, which is not described in further detail, lies across these two DC busbars P₀ and N₀. Each phase module 100 comprises an upper and a lower converter valve T1 or T3 or T5 and T2 or T4 or T6 respectively. Each of these converter valves T1 to T6 comprises a number of two-terminal subsystems 10 electrically connected in series. Four of these subsystems 10 are shown in this equivalent circuit. Each node between two converter valves T1 and T2 or T3 and T4 or T5 and T6 of a phase module 100 forms an AC-side terminal L1 or L2 or L3 respectively of this phase module 100. Since in this diagram the inverter circuit has three phase modules 100, a three-phase load, for example an AC motor can be connected to its AC-side terminals L1, L2 and L3, also known as load terminals.

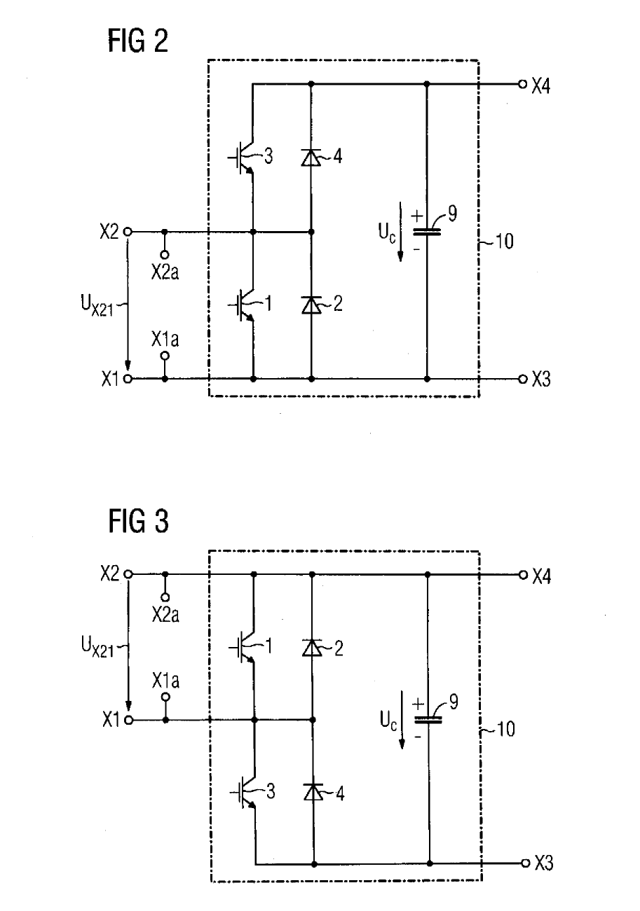

FIG. 2 shows in greater detail an equivalent circuit of a known embodiment of a two-terminal subsystem 10. The circuit arrangement of FIG. 3 shows a version that is completely identical in function, which is also disclosed in DE 101 03 031 A1. This known two-terminal subsystem 10 comprises two semiconductor switches 1 and 3 which can be switched off, two diodes 2 and 4 and a unipolar storage capacitor 9. The two semiconductor switches 1 and 3 which can be switched off are electrically connected in series, with this series circuit being electrically connected in parallel with the storage capacitor 9. Each semiconductor switch 1 and 3 which can be switched off is electrically connected in parallel with one of the two diodes 2 and 4 in such a way that this diode is connected in antiparallel with the corresponding semiconductor switch 1 or 3 which can be switched off. The unipolar storage capacitor 9 of the subsystem 10 comprises either one capacitor or a capacitor bank containing a plurality of such capacitors having a resultant capacitance Co. The junction between the emitter of the semiconductor switch 1 which can be switched off and the anode of the diode 2 forms a connecting terminal X1 of the subsystem 10. The junction between the two semiconductor switches 1 and 3 which can be switched off and the two diodes 2 and 4 form a second connecting terminal X2 of the subsystem 10.

In the embodiment of the subsystem 10 shown in FIG. 3, this junction forms the first connecting terminal X1. The junction between the collector of the semiconductor switch 1 which can be switched off and the cathode of the diode 2 forms the second connecting terminal X2 of the subsystem 10.

In both diagrams of the two embodiments of the subsystem 10, both the terminals of the storage capacitor 9 are fed out of the subsystem 10 and form two connecting terminals X3 and X4. As shown in FIGS. 2 and 3, insulated gate bipolar transistors (IGBT) are used as the semiconductor switches 1 and 3 which can be switched off. MOS field effect transistors, also known as MOS-FETs, can also be used. In addition, gate turn-off thyristors, also known as GTO thyristors, or integrated gate commutated thyristors (IGCT) can be used.

According to DE 101 03 031 A1, the subsystems 10 of each phase module 100 of the inverter circuit shown in FIG. 1 can be driven in a switching state I and II. In switching state I, the semiconductor switch 1 which can be switched off is switched on, and the semiconductor switch 3 which can be switched off is switched off. As a result, a terminal voltage U_{X21} of the subsystem 10 that exists across the connecting terminals X1 and X2 is equal to zero. In switching state II, the semiconductor switch 1 which can be switched off is switched off and the semiconductor switch 3 which can be switched off is switched on. In this switching state II, the terminal voltage U_{X21} that exists equals the capacitor voltage U_{C} across the storage capacitor 9.

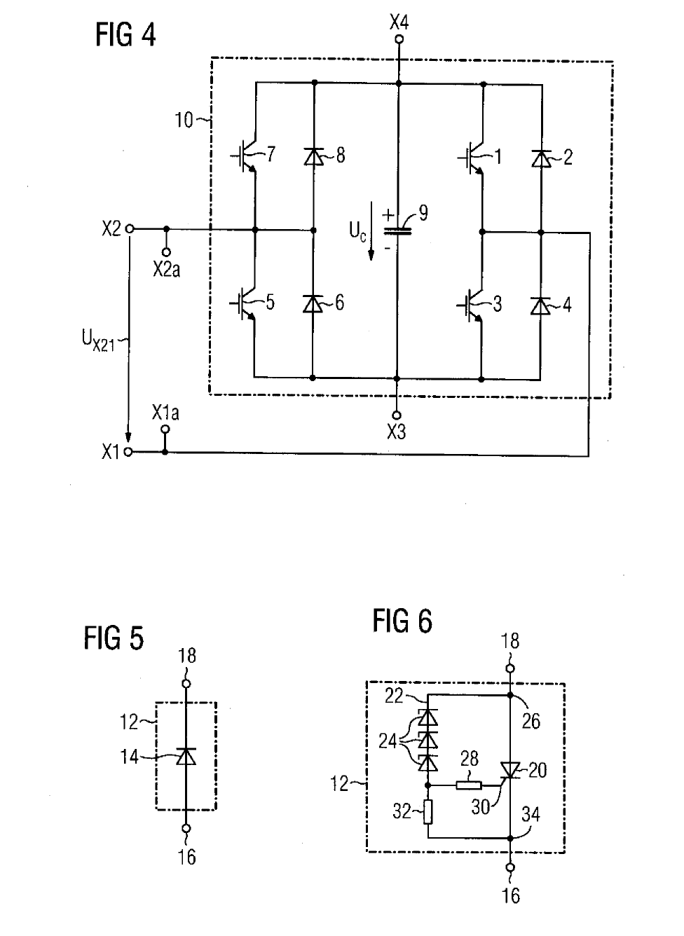

FIG. 4 shows in greater detail the equivalent circuit of another embodiment of the subsystem 10, which is disclosed in DE 102 17 889 A1. This embodiment of the subsystem 10 has the form of a full-bridge circuit of a voltage converter, except that here it is used as a single two-terminal network. This bridge circuit comprises four semiconductor switches 1, 3, 5 and 7 which can be switched off, each of which is connected in antiparallel with a diode 2, 4, 6 and 8. A storage capacitor 9, which can be charged to a voltage U_{C}, is connected across the DC-side terminals of this bridge circuit. To do this, the semiconductor switches 1, 3, 5 and 7 which can be switched off are switched off. Switching the semiconductor switches 1, 3, 5 and 7 which can be switched off produces switching states by means of which the terminal voltage U_{X21} across the connecting terminals X1 and X2 of the subsystem 10 can be positive, negative or even zero regardless of the direction of the current. Unlike the embodiment shown in FIG. 2 or 3, in this embodiment there is another switching state III, in which the terminal voltage U_{X21} of the subsystem 10 equals the negative capacitor voltage U_{C} lying across the storage capacitor 9. Again in this embodiment, the terminals of the storage capacitor 9 are fed out and denoted by X3 and X4.

In order for the inverter shown in FIG. 1 to be able to operate redundantly, it must be guaranteed that a faulty subsystem 10 is permanently short-circuited across its terminals X1 and X2, i.e. the terminal voltage U_{X21} of the faulty subsystem 10 equals zero.

Failure of one of the semiconductor switches 1, 3, 5 or 7 which can be switched off in the subsystem 10 or of an associated drive circuit means that the correct operation of this subsystem 10 is impaired, i.e. the subsystem 10 can no longer be driven in one of the possible switching states I, II or III. By short-circuiting the subsystem 10 at its terminals X1 and X2, no more energy is supplied to this subsystem 10. This definitely rules out consequential damage such as overheating and fire during continued operation of the converter. Such a short-circuit-like conducting link between the connecting terminals X1 and X2 of a faulty subsystem 10 must carry safely and without overheating at least the operating current of one converter valve T1, . . . , T6 of the phase module 100 in which the faulty subsystem 10 is connected.

U.S. Pat. No. 5,986,909 A discloses an inverter circuit, which has at least two subsystems electrically connected in series per phase module. In this known inverter circuit, frequency converters are used as the subsystems, each of which have an uncontrolled six-terminal diode bridge on the line side, and a two-phase self-commutated PWM converter on the load side. On the DC side, these two inverters are electrically connected together by a DC link circuit. On the line side, these subsystems are each connected to a secondary winding of a mains transformer. On the load side, the subsystems of a phase module are electrically connected in series. In this known inverter circuit, faulty subsystems are short-circuited, where a solenoid switch, a spring-operated contact, antiparallel thyristors or two semiconductor switches which can be switched off connected back-to-back in series are used as the bypass circuit for the load-side terminals of each subsystem. The mechanical short-circuiters require more frequent maintenance because of their mechanical design. The electrical short-circuiters each require a power supply lying at a high potential and a control device that must be connected on the control side to an inverter controller in a manner allowing signal transmission.

DE 103 23 220 A1 also discloses an inverter circuit, whose phase modules comprise at least two subsystems electrically connected in series. Each subsystem of this known inverter circuit has the form of a full-bridge circuit of a voltage converter, except that it is used as a single two-terminal network. The bridge circuit comprises four semiconductor switches which can be switched off having diodes connected in antiparallel. A storage capacitor is connected across the DC-side terminals. In order to be able to short-circuit a faulty subsystem, each subsystem comprises a protective component, which is electrically connected in parallel with the storage capacitor. A ring-back diode or a short-circuiting thyristor is used as the protective components. If a short-circuiting thyristor is used, which is connected to the storage capacitor in a low inductance manner, a sensor circuit and a trigger circuit are also needed.

In the event of a fault in a semiconductor switch which can be switched off of a subsystem, a high short-circuit current flows that can result in arcing or even the semiconductor module exploding. This short-circuit current discharges the storage capacitor. Owing to the ring-back diode connected in parallel with the storage capacitor, the short-circuit current commutates from the faulty semiconductor module to this ring-back diode, which is designed so that it becomes shorted in the event of a fault in the subsystem. In the embodiment using the short-circuiting thyristor, the DC-side short-circuit is detected by the sensor circuit, which activates the trigger circuit so that the short-circuiting thyristor triggers and becomes shorted as a result of the short-circuit current commutated to it. The disadvantage of this protective circuit is that the subsystems need to be modified in their design. In addition, a sensor circuit and a trigger circuit are required that initiate the triggering of the short-circuiting thyristor within a few milliseconds. In addition, the short-circuiting thyristor must be connected to the storage capacitor in a low inductance manner.

Hence the object of the invention is to develop the known inverter circuit containing distributed energy stores in such a way that the aforementioned disadvantages no longer occur.

This object is achieved according to the invention by the characterizing feature of claim 1.

By electrically connecting a protective component in parallel with the connecting terminals of each system, the facility is provided of being able to short-circuit this subsystem in the event of a fault. Since this protective component is connected across the connecting terminals of the subsystem, the design of the subsystem is unaffected. This means that subsystems that still do not have a protective component, can subsequently be provided with such a component. The protective components are designed such that they go into a short-circuit-like state after absorbing a defined amount of overvoltage energy. This means that these protective components become shorted in the event of a fault in a corresponding subsystem, whereby this protective system is short-circuited.

For a protective component of a faulty subsystem to be able to become shorted, it is first necessary to determine which of the subsystems present in the phase modules of the inverter circuit is faulty. As soon as a faulty subsystem is located, a defined amount of overvoltage energy is fed to the faulty subsystem by driving one or more fault-free subsystems selectively. For this purpose, it is possible to drive into a switching state I for a predetermined time period at least one subsystem of a phase module, in which the faulty subsystem is disposed, of the inverter circuit. In addition, in each of the fault-free phase modules of the inverter circuit, additionally at least one subsystem is driven into a switching state II for a predetermined time period.

Instead of driving an additional subsystem in a faulty phase module into the switching state I, and an additional subsystem in each of the fault-free phase modules into the switching state II, all of the subsystems of each of the fault-free phase modules can be driven into the switching state II, and all the fault-free subsystems of the faulty phase module can be driven into the switching state I. A maximum adjustable overvoltage can thereby be applied across the faulty subsystem, so that it drives a current through the input-side protective component that results in this protective component becoming shorted.

The switching period is suitably adjusted in order to limit the peak value of the current through the protective component to values that are admissible for the intact semiconductor switches which can be switched off. The number of subsystems that are driven additionally into a switching state I and II can be used to adjust incrementally the overvoltage applied across the faulty subsystem.

The invention is explained in further detail with reference to the drawing, which shows schematically a number of embodiments of a protective component according to the invention.

FIG. 1 shows an equivalent circuit of a known inverter circuit with distributed energy stores,

FIG. 2 shows an equivalent circuit of a first embodiment of a known subsystem,

FIG. 3 shows an equivalent circuit of a second embodiment of a known subsystem,

FIG. 4 shows an equivalent circuit of a third embodiment of a known subsystem, and

FIGS. 5 to 10 show in greater detail various embodiments of a protective component according to the invention.

FIG. 5 shows a first protective component 12 for a subsystem 10 as shown in FIG. 2 or 3. A diode 14 is provided as the protective component 12. A series circuit of a plurality of diodes can also be provided instead of this one diode 14. This protective component 12 is connected by its connecting terminals 16 and 18 to the connecting terminals X1 and X2, in particular to the terminals X1a and X2a, of a subsystem 10 as shown in FIG. 2 or 3.

FIG. 6 shows a second embodiment of a protective component 12 according to the invention. In this case, a thyristor 20 having an active clamping circuit 22 as it is known, is provided as the protective component 12. This active clamping circuit 22 comprises at least one Zener diode 24, which is connected on the cathode side to an anode terminal 26 of the thyristor 20, and on the anode side to a gate terminal 30 of the thyristor 20 via a gate resistor 28. On the anode side, the Zener diode 24 is also electrically connected to a cathode terminal 34 of the thyristor 20 via a resistor 32. As soon as a voltage at the anode 26 of the thyristor 20 exceeds the Zener value of the Zener diodes 24, they start to conduct and switch on the thyristor 20. The current now flowing through the thyristor 20 ensures that the thyristor safely becomes shorted. The thyristor 20 is designed so that this current safely results in shorting.

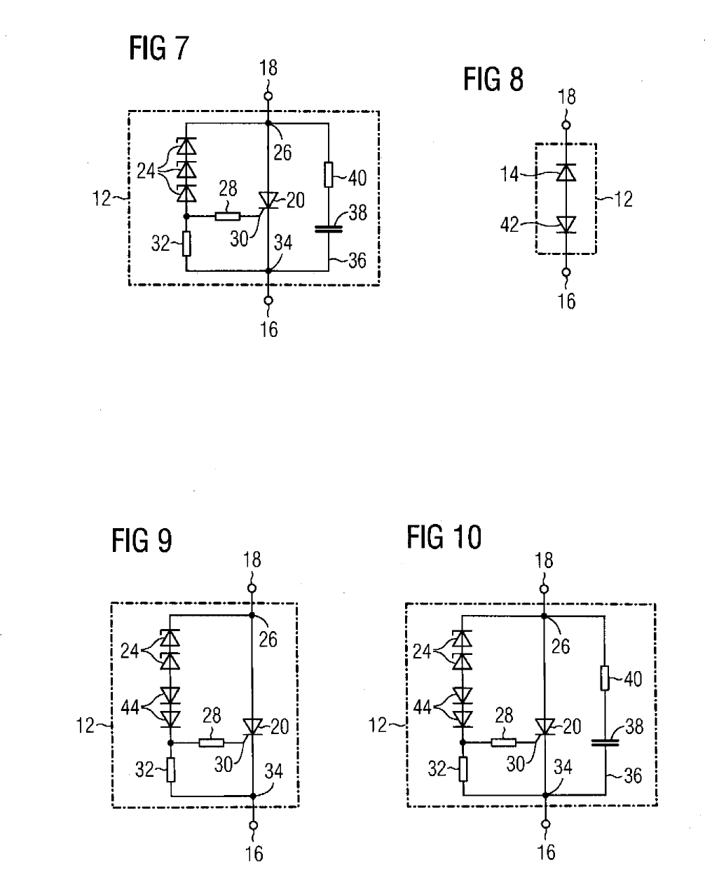

The embodiment of the protective component 12 shown in FIG. 7 is essentially identical to the embodiment shown in FIG. 6. The difference lies in the fact that the embodiment shown in FIG. 7 also comprises an RC circuit that is electrically connected in parallel with the anode-cathode path of this thyristor 20. This RC circuit 36 comprises a capacitor 38 and a resistor 40, which are electrically connected in series. The switching edges of the switching operations of the semiconductor switches 1 and 3 which can be switched off of an associated subsystem 10 are attenuated by this RC circuit 36. This prevents the protective component 12 from being driven by a switching edge of a subsystem 10.

FIG. 8 shows in greater detail a further embodiment of the protective component 12. This protective component 12 comprises two diodes 14 and 42, which are electrically connected in series back-to-back. This embodiment makes this protective component 12 capable of accepting a positive and a negative voltage. This means that when a subsystem is fault free, it shall not be short-circuited on the input side. Hence, when a subsystem is fault free, the protective component 12 must safely be able to accept the applied terminal voltage U_{X21}. Since, unlike the terminal voltage U_{X21} of the subsystem 10 shown in FIG. 2 or 3, the terminal voltage U_{X21} in the embodiment of the subsystem 10 shown in FIG. 4 can also be negative, a protective component 12 is needed that can accept a voltage in both directions. Instead of in each case one diode 14 or 42, a plurality of diodes can also be used here in each case.

The embodiment of the protective component 12 shown in FIG. 9 is essentially identical to the embodiment shown in FIG. 6. The difference lies in the fact that at least one decoupling diode 44 is connected between the Zener diodes 24 on the anode side and the gate resistor 28. For this purpose, this decoupling diode 44 is electrically connected on the cathode side to the gate resistor 28 and on the anode side to the anode of the Zener diode 24. This additional decoupling diode 44 means that this protective component 12 can accept voltage in both directions. This protective component 12 can thereby be electrically connected by its connecting terminals 16 and 18 in parallel with the connecting terminals X1 and X2, in particular X1a and X2a, of a subsystem 10 as shown in FIG. 4.

The embodiment of the protective component 12 shown in FIG. 10 corresponds to the embodiment shown in FIG. 9, with an RC circuit 36 being additionally electrically connected in parallel with the anode-cathode path of the thyristor 20.

The control method according to the invention shall now be described in greater detail with reference to the equivalent circuit shown in FIG. 1.

In the equivalent circuit shown in FIG. 1, a subsystem 10 of the converter valve T2 is faulty. This is identified by shading. Additional impedances Z representing the summated values of the inductances (stray inductances) and resistances that exist in the bridge halves are inserted in the phase modules 100 of this three-phase inverter circuit shown in FIG. 1. Discrete components can also be arranged in the phase modules 100 in addition to these parasitic impedances.

Voltage detection with subsequent comparison with a preset tolerance band is used to determine when there is a fault in a subsystem 10. In addition, other faults can also result in failure of the subsystem, e.g. malfunctioning of the electronics, or a communications fault. These faults are detected by the controller and also necessarily result in the short-circuiting of a subsystem. If the shaded subsystem 10 of the converter valve T2 now fails, then the maximum amount of energy available to generate a defined overvoltage energy to cause the protective component 12 of the shaded subsystem 10 of the thyristor valve T2 to become shorted is the energy contained in all the subsystems 10 of the phase module 100 containing the converter valves T3 and T4 and of the phase module 100 containing the converter valves T5 and T6. For this purpose, all the subsystems 10 of these two fault-free phase modules 100 could be driven into the switching state II, while all the fault-free subsystems 10 of the faulty phase module 10 are driven into the switching state I. In switching state II, the terminal voltage U_{X21} lying across the subsystem 10 equals the capacitor voltage U_{C} lying across the storage capacitor 9. In switching state I, the terminal voltage U_{X21} lying across the subsystem 10 equals zero. The currents i_{K1}, i_{K2} and i_{K3} identified by the arrows in FIG. 1 flow as a result of this drive of the subsystems 10. A time period for each of these switching states I and II must be suitably adjusted in order to limit the peak value of these currents i_{K1}, i_{K2} and i_{K3} to values that are admissible for intact semiconductor switches 1, 3, 5 and 7 which can be switched off of the subsystems 10. This time period can be determined in advance if the impedances Z are known. This drive of the subsystems 10 results in an overvoltage across the faulty subsystem 10 whose energy is absorbed by the corresponding protective component 12. This causes the protective component 12 to go into a short-circuit-like state, i.e. the protective component 12 becomes shorted.

Since the maximum available energy is easily sufficient, this described control method is modified. In the modified control method, in the faulty phase module 100, which comprises the two converter valves T1 and T2 according to the equivalent circuit of FIG. 1, just one subsystem 10 is additionally driven into the switching state I compared with normal operation, and in the fault-free phase modules 100 just one subsystem 10 in each case is additionally driven into the switching state II. The resultant voltage lying across the faulty subsystem 10 is sufficient to make the associated protective component 12 become shorted.

The subsystems 10 used, and the respective number per phase module 100, must be chosen to ensure that both the current directions shown in FIG. 1 by currents i_{K2} and i_{K3}, and the opposite direction of the current i_{K1}, can be set up using the fault-free phase modules 100.

By means of this drive of the subsystems 10 of the phase modules 100 of a multi-phase inverter circuit, the DC voltage across the DC busbars P₀ and N₀, and the AC voltage across the load terminals L1, L2 and L3 are only slightly affected compared with normal operation, and only for the time period.

A height of the resultant current pulse admissible for intact semiconductor switches which can be switched off can be calculated in advance, as already mentioned. The current pulse can also be measured if there are measurements of the branch currents available. In this way, it is possible to work with a variable time period that is adjusted so as to achieve a predetermined maximum current.

Said switching states of the time period can also be driven repeatedly many times, with the number of these driven switching states and a time interval between these repetitions being chosen so that a storage capacitor 9 of a faulty subsystem 10 that is fully discharged in the limiting case is re-charged as quickly as possible.

1.-18. (canceled)

19. An inverter circuit, comprising:
at least one phase module connected between a positive and a negative DC busbar on a DC side of an inverter and having two converter valves, each of the converter valves including at least two serially connected two-terminal subsystems having connecting terminals, and
a plurality of protective components connected to the subsystems in one-to-one correspondence, wherein the protective components are connected in parallel with the connecting terminals of the subsystems.

20. The inverter circuit of claim 19, wherein each two-terminal subsystem comprises two serially connected turn-off semiconductor switches, a unipolar storage capacitor connected in parallel with the serially connected turn-off semiconductor switches, and two diodes, with each of the two diodes being connected antiparallel with a corresponding one of the two turn-off semiconductor switches.

21. The inverter circuit of claim 20, wherein one the connecting terminals is connected to a center tap of the serially connected turn-off semiconductor switches and the other connecting terminal is connected to an end tap of the serially connected turn-off semiconductor switches.

22. The inverter circuit of claim 19, wherein each two-terminal subsystem comprises four serially connected turn-off semiconductor switches forming a bridge circuit having AC-side terminals forming the connecting terminals and DC-side terminals, a storage capacitor connected to the DC-side terminals, and four diodes, with each of the four diodes being connected antiparallel with a corresponding one of the four turn-off semiconductor switches.

23. The inverter circuit of claim 19, wherein the protective component is implemented as a diode.

24. The inverter circuit of claim 19, wherein the protective component is implemented as a thyristor having an anode and a gate, wherein the anode is connected to the gate via an active clamping circuit.

25. The inverter circuit of claim 19, wherein the protective component comprises two diodes connected in series back-to-back.

26. The inverter circuit of claim 19, wherein the protective component is implemented as a thyristor having an anode and a gate, wherein the anode is connected to the gate via Zener diodes and decoupling diodes.

27. The inverter circuit of claim 24, further comprising a gate resistor connected to the gate of the thyristor.

28. The inverter circuit of claim 26, further comprising a gate resistor connected to the gate of the thyristor.

29. The inverter circuit of claim 24, further comprising an RC circuit connected in parallel with the anode and a cathode of the thyristor.

30. The inverter circuit of claim 26, further comprising an RC circuit connected in parallel with the anode and a cathode of the thyristor.

31. The inverter circuit of claim 20, wherein the turn-off semiconductor switches are implemented as insulated gate bipolar transistors.

32. The inverter circuit of claim 20, wherein the turn-off semiconductor switches are implemented as MOS field effect transistors.

33. The inverter circuit of claim 20, wherein the turn-off semiconductor switches are implemented as gate turn-off thyristors.

34. The inverter circuit of claim 20, wherein the turn-off semiconductor switches are implemented as integrated gate commutated thyristors.

35. A control method for an inverter circuit with at least one phase module having two converter valves and being connected between a positive a negative DC busbar on a DC side of an inverter and, each converter valve including at least two serially connected two-terminal subsystems, said control method comprising the following steps:
a). identifying a faulty phase module having a failed subsystem,
b). driving at least one additional subsystem of the identified faulty phase module into a first switching state for a predetermined time period, and
c). driving at least one subsystem of a fault-free phase module into a second switching state for another predetermined time period.

36. The control method of claim 35, further comprising the step of repeating steps b) and c) at least once, with a predetermined time interval being observed between repetitions.

37. The control method of claim 35, further comprising the steps of determining a corresponding voltage across a storage capacitor of each subsystem, comparing the determined voltages with a preset tolerance band, and identifying a subsystem as having failed if the determined voltage lies outside the preset tolerance band.
